(19) United States
(12) Patent Application Publication
(10) Pub. No.: US 2002/0125240 A1
(43) Pub. Date: Sep. 12, 2002

(54) Heating device, method for producing same and film forming apparatus

(76) Inventors: Kazumi Ogura, Kobe-shi (JP); Kiyoshi Watanabe, Kobe-shi (JP); Hirofumi Furukawa, Takasago-shi (JP)

Correspondence Address: BIRCH STEWART KOLASCH & BIRCH, PO BOX 747, FALLS CHURCH, VA, 22040-0747, US

(21) Appl. No.: 10/084,180

(22) Filed: Feb. 28, 2002

(30) Foreign Application Priority Data
Mar. 9, 2001 (JP) 2001-66129

(51) Int. Cl. F27B 5/14; H05B 3/30

(52) U.S. Cl. 219/444.1; 118/725

(57) ABSTRACT

A heating device producible at a low cost and capable of heating to high temperatures, a method for producing the heating device, and a film forming apparatus using the heating device are provided. The heating device comprises a support base adapted to support a substrate and comprising aluminum or an aluminum alloy, a sheathed heater provided within the support base, and support plates provided within the support base and comprising a metallic material having a melting point of 850° C. or higher.

The entire disclosure of Japanese Patent Application No. 2001-66129 filed on Mar. 9, 2001 including specification, claims, drawings and summary is incorporated herein by reference in its entirety.

### BACKGROUND OF THE INVENTION

1. Field of the Invention

This invention relates to a heating device, a method for producing the heating device, and a film forming apparatus using the heating device.

2. Description of the Related Art

A film forming apparatus for forming a film on the surface of a substrate to produce a semiconductor, a liquid crystal, etc., for example, directs a plasma of a gas of a starting material for the film at the substrate while heating the substrate in a vacuum environment, thereby forming the film on the surface of the substrate (plasma chemical vapor deposition or plasma CVD).

A heating device (susceptor) used in such a film forming apparatus, as shown in FIGS. 6A and 6B, comprises a support base 111 of aluminum or an aluminum alloy, and an electric resistance sheathed heater 112 buried in the support base 111, end portions of the sheathed heater 112 being electrically connectable to the outside via a lower portion of the support base 111.

Such a heating device 110 is produced, for example, by cutting the support base 111 to form a groove 111a in agreement with the buried shape of the sheathed heater 112, laying the sheathed heater 112 in the groove 111a, closing the groove 111a with a cover 111b fitted in the groove 111a, welding the cover 111b, and then polishing the surface of the support base 111.

According to a plasma CVD film forming apparatus equipped with the heating device 110, a film can be formed on a substrate in the following manner: The substrate is placed on the support base 111 of the heating device 110, and the sheathed heater 112 of the heating device 110 is energized. As a result, the support base 111 is heated to about 350° C. or lower to heat the substrate. In a vacuum environment, a plasma of a gas of a starting material for the film is directed at the substrate, whereby the film is formed on the substrate.

The support base 111 of the heating device 110 is composed of aluminum or an aluminum alloy. Thus, the support base 111 is light in weight, high in thermal conductivity, and can heat the substrate with high efficiency. Moreover, its constituent component (aluminum) minimally vapor-deposits on the substrate, and does not adversely affect a semiconductor or liquid crystal produced.

However, the heating device 110 involves the following problems:

(1) To increase the efficiency of film formation or upgrade the performance of the resulting film, heating of the substrate to a higher temperature of 400 to 500° C. is required in the film forming apparatus. If it is attempted to heat the substrate to 400-500° C. in the conventional heating device 110, however, the substrate 111 (500 to 1,600 mm square) softens, because the heating temperature is close to the melting point of aluminum (about 660° C.). Thus, the substrate 111 bends under its own weight, and cannot stably support the substrate any longer.

(2) The heating device 110 is produced by cutting the support base 111 to form the groove 111a, laying the sheathed heater 112 in the groove 111a, and welding the cover 111b fitted in the groove 111a. This production necessitates much labor, becoming one of factors for an increased cost.

The above-described problems are not limited to the aforementioned plasma CVD film forming apparatus for producing a semiconductor or a liquid crystal, but they are fully conceivable in the case of a film forming apparatus which comprises a heating device for holding and heating an article to be heated, and film material throwing means for throwing a material for a film onto the article to be heated.

### SUMMARY OF THE INVENTION

The present invention has been accomplished in consideration of the above problems with the earlier technology. It is the object of the invention to provide a heating device producible at a low cost and capable of heating to a high temperature, a method for producing the heating device, and a film forming apparatus using the heating device.

A heating device according to the present invention comprises a support base adapted to support an article to be heated and comprising aluminum or an aluminum alloy, heating means provided within the support base, and a skeletal member provided within the support base and comprising a metallic material having a melting point of 850° C. or higher.

The skeletal members may be disposed so as to be vertically symmetrical with respect to the heating means.

Also, the skeletal member may be slab-shaped.

Also, a plurality of holes may be formed in the skeletal member.

The holes may be in a honeycomb pattern.

Also, the aluminum alloy may have low contents of magnesium and copper.

Also, the skeletal member may comprise one of iron, steel, nickel, a nickel alloy, titanium, a titanium alloy, copper, and a copper alloy.

A method for producing a heating device, according to the present invention, comprises disposing heating means within a mold having a lower portion comprising a metal mold and a side portion comprising a sand mold; pouring a melt of aluminum or an aluminum alloy into the mold; and covering a surface of the melt with an exothermic heat insulating material, whereby directional solidification of the melt takes place from a lower side toward an upper side to cast the melt.

Alternatively, a method for producing a heating device, according to the present invention, is a method for producing the above-mentioned heating device, comprising disposing the heating means and the skeletal member within a mold having a lower portion comprising a metal mold and a side portion comprising a sand mold; pouring a melt of aluminum or an aluminum alloy into the mold; and covering a surface of the melt with an exothermic heat insulating material, whereby directional solidification of the melt takes place from a lower side toward an upper side to cast the melt.

A film forming apparatus, according to the present invention, comprises the above-mentioned heating device for holding and heating an article to be heated; and film material throwing means for throwing a material for a film onto the article to be heated.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic configuration drawing of a first embodiment of a film forming apparatus according to the present invention;

FIGS. 2A and 2B are schematic configuration drawings of a first embodiment of a heating device according to the present invention;

FIG. 3 is an explanation drawing of a method for producing the heating device shown in FIGS. 1, 2A and 2B;

FIGS. 4A and 4B are schematic configuration drawings of a second embodiment of a heating device according to the present invention;

FIG. 5 is a schematic configuration drawing of a third embodiment of a heating device according to the present invention; and

FIGS. 6A and 6B are schematic configuration drawings of an example of a conventional heating device.

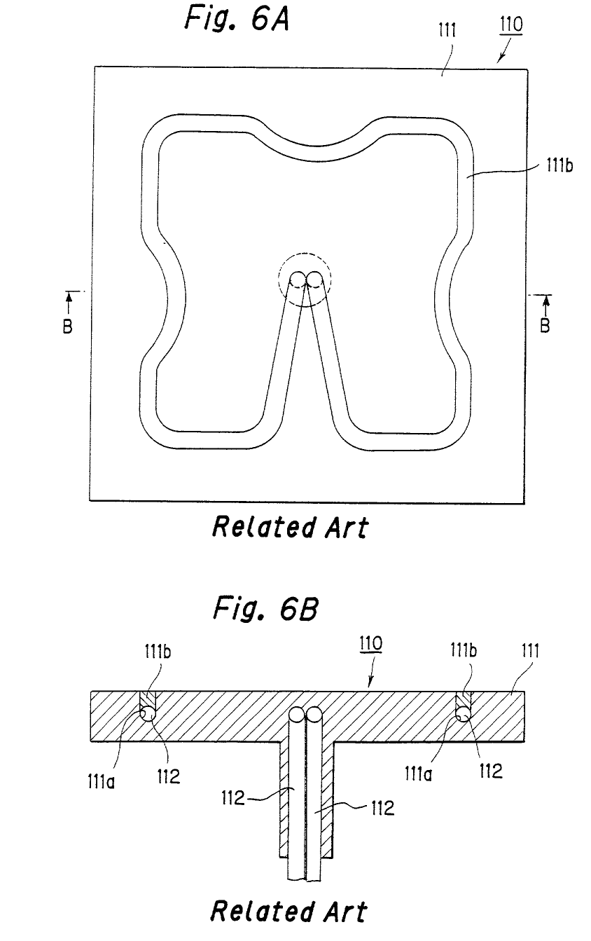

### DESCRIPTION OF THE PREFERRED EMBODIMENTS

Preferred embodiments of a heating device according to the present invention, a method for producing the heating device, and a film forming apparatus using the heating device will now be described in detail with reference to the accompanying drawings, but in no way limit the present invention.

First Embodiment

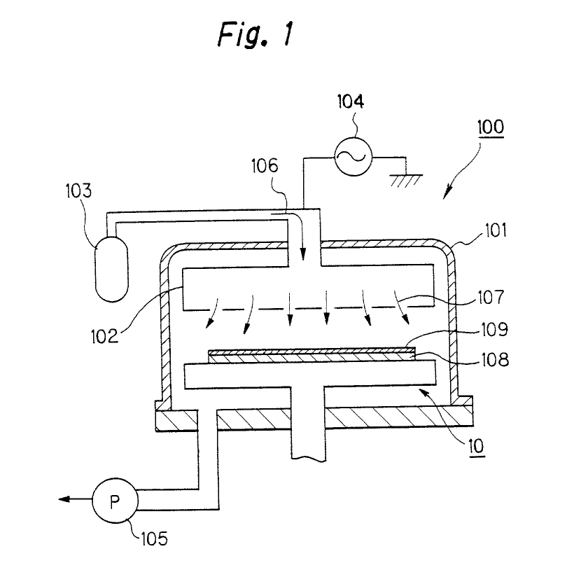

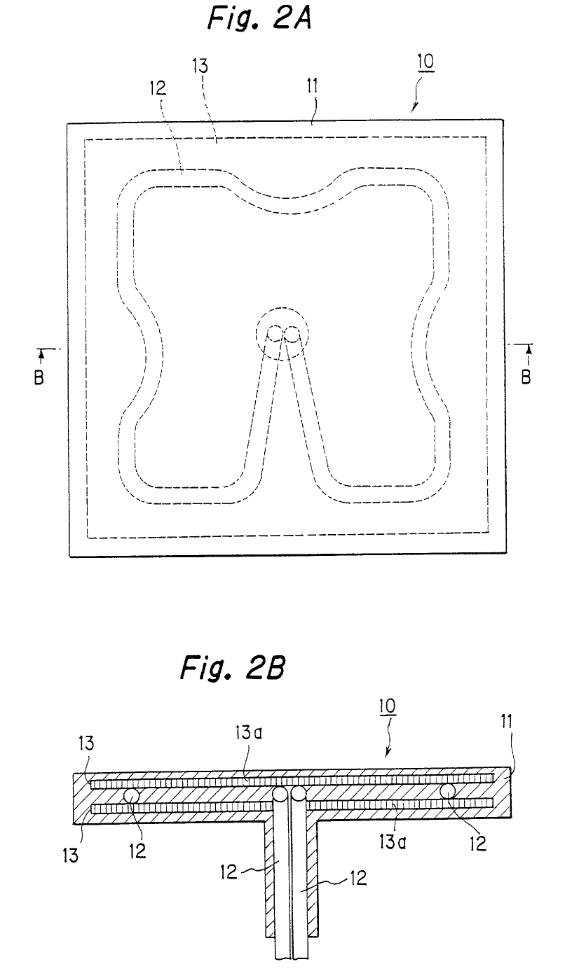

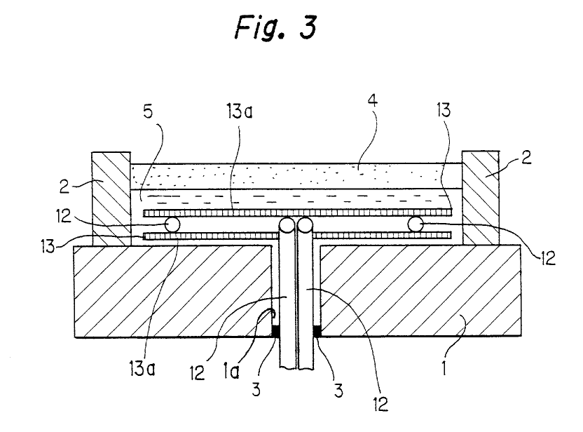

A first embodiment of a heating device according to the present invention, a method for producing the heating device, and a film forming apparatus using the heating device is described by reference to FIGS. 1 to 3. FIG. 1 is a schematic configuration drawing of the film forming apparatus. FIGS. 2A and 2B are schematic configuration drawings of the heating device. FIG. 3 is an explanation drawing of the method for producing the heating device.

As shown in FIG. 1, a heating device (susceptor) 10, which holds and heats a substrate 108 as an article to be heated, is disposed in a lower portion of the interior of a chamber 101. A plasma generating device 102 is disposed above the heating device 10 in an upper portion of the interior of the chamber 101. The plasma generating device 102 serves as film material throwing means for throwing a plasma 107 of a gas 106 of a material for a film onto the substrate 108. A gas supply source 103 for feeding the gas 106 of the film material, and a power source 104 are connected to the plasma generating device 102. A pressure reducing pump 105 as pressure reducing means is connected to the chamber 101.

The heating device 10, as shown in FIGS. 2A and 2B, comprises a support base 11 of aluminum or an aluminum alloy, an electric resistance sheathed heater 12 (heating means comprising a nichrome wire disposed within a tube of a stainless or nickel alloy) buried in the support base 11, and a pair of slab-shaped support plates 13, as a skeletal member, buried in the support base while surrounding and sandwiching the sheathed heater 12 from above and from below, namely, so as to be vertically symmetric with respect to the sheathed heater 12. The support plate 13 has a plurality of holes 13a in a honeycomb pattern piercing therethrough in a thickness direction (vertical direction), and comprises a metallic material (e.g., iron or steel, nickel or its alloy, titanium or its alloy, or copper or its alloy) having a melting point of 850° C. or higher (preferably, 1,000° C. or higher).

A method for producing the heating device 10 is explained with reference to FIG. 3.

Aluminum or an aluminum alloy is melted in a melting furnace (a fuel oil combustion furnace, a gas combustion furnace, or an electric furnace), and the molten metal is transferred into a ladle. A nitrogen gas is blown into the molten metal for 10 to 15 minutes to degas (dehydrogenate) the molten metal.

Separately, the sheathed heater 12 is sandwiched in a vertical direction between the support plates 13 as a pair, and the support plates 13 and the sheathed heater 12 are temporarily tacked by, for example, spot welding to avoid their displacement with respect to each other. As shown in FIG. 3, end portions of the sheathed heater 12 are passed through a hole 1a bored in a central portion of a flat plate-shaped metal mold (chiller) 1. Then, the end portions of the sheathed heater 12 are removably supported such that the sheathed heater 12 and the support plates 13 are located at a predetermined height from the surface of the metal mold 1.

Then, a □-shaped sand mold 2 is disposed on the upper surface of the metal mold 1 so as to surround the sheathed heater 12 and the support plates 13. Also, a ceramic sealing material 3 is filled between the lower end of the hole 1a of the metal mold 1 and the end portions of the sheathed heater 12 to close the gap between them. Then, the metal mold 1 and the sand mold 2 are preheated to about 50 to 80° C.

Then, the molten metal 5 is poured into a mold composed of the metal mold 1 and the sand mold 2, and the surface of the molten metal 5 is covered with an exothermic heat insulating material 4 comprising a mixture of a metal oxide (e.g., iron oxide) powder and an aluminum powder. The temperature of the molten metal 5 is preferably 680 to 750° C. in the case of aluminum, or 650 to 700° C. in the case of the aluminum alloy.

The molten metal 5 has a face side kept warm by the exothermic reaction of the exothermic heat insulating material 4, has a side surface kept warm by the sand mold 2, and has a lower portion cooled by the metal mold (chiller) 1. Thus, the molten metal 5 undergoes cooling and solidification taking place in one direction from the lower side to the upper side (namely, directional solidification). By casting and solidification performed in this manner, the molten metal 5 can be solidified without occurrence of defects, such as gas holes and shrinkage cavities.

After the molten metal 5 is solidified as a whole, the solidified product is withdrawn from the mold (metal mold 1 and sand mold 2), and subjected to finishing, such as polishing, whereby the heating device 10 can be produced.

In a plasma CVD film forming apparatus 100 using the so produced heating device 10, as shown in FIG. 1, the substrate 108 (e.g., a substrate of a silicon material) is placed on the support base 11 of the heating device 10, and the sheathed heater 12 of the heating device 10 is energized. At the same time, the pressure reducing pump 105 is actuated to reduce the pressure inside the chamber 101. Also, the gas 106 (for example, a mixture of a silicon hydride gas and a hydrogen gas) is fed from the gas supply source 103 to the plasma generating device 102, while the power source 104 is actuated. As a result, the support base 11 is heated to 400 to 500° C. to heat the substrate 108. Simultaneously, the gas 106 is converted into a plasma by the plasma generating device 102. The resulting plasma 107 is directed from the plasma generating device 102 toward the substrate 108 to form a high performance film 109 (for example, a polycrystalline silicon film) on the substrate 108 with high efficiency. In this manner, a semiconductor can be produced.

Hence, the following effects can be obtained according to the present embodiment:

(1) The heating device 10 comprises the support base 11 of aluminum or an aluminum alloy, and the support plates 13 provided in the support base 11, the support plates 13 each comprising a metallic material having a melting point of 850° C. or higher. Thus, even when the support base 11 is heated to 400 to 500° C., the support base 11 can be held, without being deformed, by the support plates 13, so that the substrate 108 can be held stably.

(2) The heating device 10 is produced by the casting method such that the sheathed heater 12 and the support plates 13 are built into the support base 11. Thus, the heating device 10 can be continuously produced with ease, as compared with the conventional heating device 110 which is produced by cutting the support base 111 to form the groove 111a, laying the sheathed heater 112 in the groove 111a, then fitting the cover 111b onto the groove 111a, and welding the cover 111b. Consequently, the manufacturing cost can be reduced markedly.

(3) The molten metal 5 undergoes cooling and solidification taking place in one direction from the lower side to the upper side (namely, directional solidification). Thus, the molten metal 5 can be solidified without occurrence of defects, such as gas holes and shrinkage cavities.

(4) The holes 13a in a honeycomb pattern are formed in the support plates 13 of the heating device 10. Thus, weight reduction can be achieved, with rigidity being retained. Moreover, directional solidification of the molten metal 5 for the production of the heating device 10 by casting can be performed uniformly. Accordingly, the product of a higher quality can be obtained.

(5) The pair of support plates 13 are provided within the support base 11 so as to surround the sheathed heater 12 while sandwiching the sheathed heater 12 in the vertical direction, namely, so as to be symmetric with respect to the sheathed heater 12 in the vertical direction. Thus, the speed of heating of the support base 11 by the sheathed heater 12 in the vertical direction is uniformized, and differences in thermal expansion of the support base 11 in the vertical direction can be eliminated. Hence, the warpage of the support base 11 upon heating can be prevented, and the substrate 108 can be stably held more reliably.

The preferred material for the support base 11 of the heating device 10 is aluminum or an aluminum alloy which is light in weight, high in thermal conductivity, can heat the substrate 108 with high efficiency, and has satisfactory castability, and whose constituent component minimally vapor-deposits on the substrate, and does not adversely affect a semiconductor or liquid crystal produced. The preferred aluminum alloy has a low content of magnesium which is liable to evaporate, or a low content of copper which, if vapor-deposited on the substrate, is likely to exert adverse influence on the resulting semiconductor or liquid crystal. For example, “AC3A”, “AC4C” or “AC4CH”, referred to in the Japanese Industrial Standards, is preferred.

The material for the support plate 13 may be a metallic material having a melting point of 850° C. or higher, preferably 1,000° C. or higher. If the melting point is lower than 850° C., the support plate 13 may be deformed due to the heat of the molten metal 5 during manufacturing of the heating device 10. Furthermore, upon heating of the support base 11 up to 400 to 500° C., it is difficult for the support plates 13 to hold the support base 11 with sufficient rigidity. The melting point of 1,000° C. or higher, in particular, is very preferred, because the support plate is completely free from the above problems.

Particularly preferred as the metallic material is one of iron, steel, nickel, nickel alloy, titanium, titanium alloy, copper, and copper alloy. This is because the support plate 13 can be produced at a low cost from iron or steel (stainless steel, etc.); the heat resistance of the support plate 13 can be increased with the use of nickel or nickel alloy; the thermal conductivity of the support plate 13 can be increased in the case of copper or copper alloy; and the weight of the support plate 13 can be decreased by use of titanium or titanium alloy.

The use of the support plate 13 comprising a ceramic material (melting point: 850° C. or higher) causes a great difference in coefficient of thermal expansion between the support base 11 comprising aluminum or aluminum alloy and the support plate 13. As a result, the support plate 13 may develop cracks or crazes. Thus, a ceramic material is difficult to apply to the support plate.

Second Embodiment

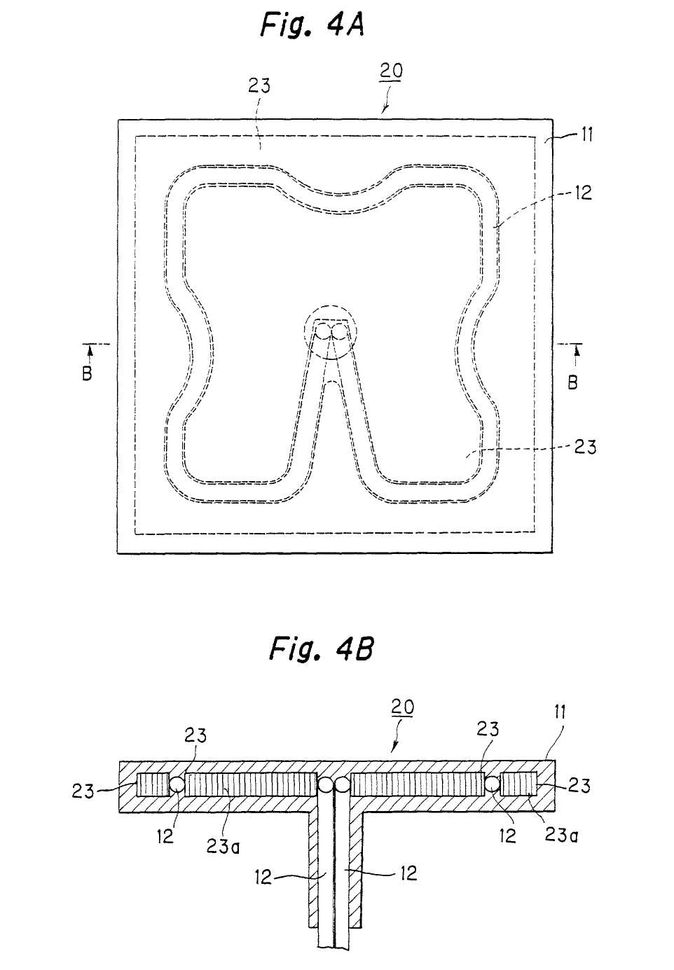

A second embodiment of a heating device according to the present invention, a method for producing the heating device, and a film forming apparatus using the heating device is described by reference to FIGS. 4A and 4B. FIGS. 4A and 4B are schematic configuration drawings of the heating device. The same members as described in the First Embodiment are assigned the same numerals as used in the descriptions of the First Embodiment, and their explanations are omitted.

A heating device 20 according to the present embodiment, as shown in FIGS. 4A and 4B, comprises a support base 11, a sheathed heater 12 buried in the support base 11, and slab-shaped support plates 23, as a skeletal member, buried in the support base 11 so as to surround and sandwich the sheathed heater 12 in a horizontal direction. The support plates 23 are disposed such that the upper half and lower half of each of the support plates are vertically symmetric about the sheathed heater 12. The support plate 23 has a plurality of holes 23a in a honeycomb pattern piercing therethrough in a thickness direction (vertical direction), and comprises a material having a melting point of 850° C. or higher (preferably, 1,000° C. or higher).

Such a heating device 20 can be easily produced by the same casting method as for the heating device 10 of the aforementioned First Embodiment.

The heating device 20 can be applied to the film forming apparatus 100 in the same manner as is the heating device 10 of the First Embodiment.

In the First Embodiment, the sheathed heater 12 is vertically sandwiched between and surrounded by the support plates 13. In the present embodiment, on the other hand, the sheathed heater 12 is horizontally sandwiched between and surrounded by the support plates 23.

Hence, the following effects can be obtained according to the present embodiment:

(1) Like the heating device 10 of the First Embodiment, the heating device 20 comprises the support base 11 of aluminum or an aluminum alloy, and the support plates 23 provided in the support base 11, the support plates 23 each comprising a material having a melting point of 850° C. or higher. Thus, even when the support base 11 is heated to 400 to 500° C., the support base 11 can be held, without being deformed, by the support plates 23, so that the substrate 108 can be held stably.

(2) Like the heating device 10 of the First Embodiment, the heating device 20 is produced by the casting method such that the sheathed heater 12 and the support plates 23 are built into the support base 11. Thus, the heating device 20 can be continuously produced with ease, as compared with the conventional heating device 110 which is produced by cutting the support base 111 to form the groove 111a, laying the sheathed heater 112 in the groove 111a, then fitting the cover 111b onto the groove 111a, and welding the cover 111b. Consequently, the manufacturing cost can be reduced markedly.

(3) In the same manner as in the First Embodiment, the molten metal 5 undergoes cooling and solidification taking place in one direction from the lower side to the upper side (namely, directional solidification). Thus, the molten metal 5 can be solidified without occurrence of defects, such as gas holes and shrinkage cavities.

(4) As in the heating device 10 of the First Embodiment, the holes 23a in a honeycomb pattern are formed in the support plates 23 of the heating device 20. Thus, weight reduction can be achieved, with rigidity being retained. Moreover, directional solidification of the molten metal 5 for the production of the heating device 20 by casting can be performed uniformly. Accordingly, the product of a higher quality can be obtained.

(5) The support plates 23 are provided within the support base 11 so as to surround the sheathed heater 12 while sandwiching the sheathed heater 12 in the horizontal direction. The support plates 23 are disposed such that the upper half and lower half of each of the support plates are vertically symmetric about the sheathed heater 12. Thus, as in the heating device 10 of the First Embodiment, the speed of heating of the support base 11 by the sheathed heater 12 in the vertical direction is uniformized, and differences in thermal expansion of the support base 11 in the vertical direction can be eliminated. Hence, the warpage of the support base 11 upon heating can be prevented, and the substrate 108 can be stably held more reliably.

Third Embodiment

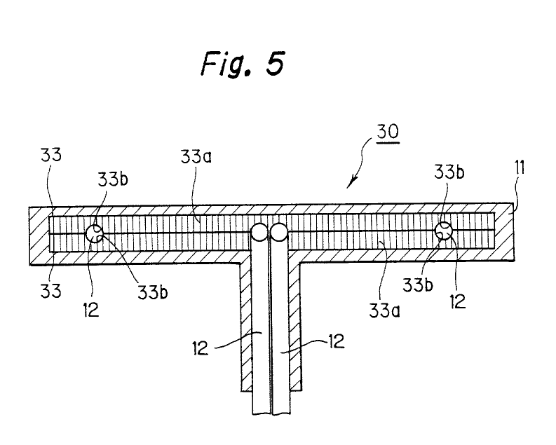

A third embodiment of a heating device according to the present invention, a method for producing the heating device, and a film forming apparatus using the heating device is described by reference to FIG. 5. FIG. 5 is a schematic configuration drawing of the heating device. The same members as described in the First and Second Embodiments are assigned the same numerals as used in the descriptions of the First and Second Embodiments, and their explanations are omitted.

A heating device 30 according to the present embodiment, as shown in FIG. 5, comprises a support base 11, a sheathed heater 12 buried in the support base 11, and a pair of slab-shaped support plates 33, as a skeletal member, buried in the support base 11 so as to sandwich the sheathed heater 12 in a vertical direction, namely, so as to be vertically symmetric with respect to the sheathed heater 12. A plurality of holes 33a in a honeycomb pattern pierce through each of the support plates 33 in a thickness direction (vertical direction), and a groove 33b to be fitted with the sheathed heater 12 is formed in one surface of each of the support plates 33. The support plate 33 comprises a material having a melting point of 850° C. or higher (preferably, 1,000° C. or higher). The sheathed heater 12 is sandwiched between the one surface of one of the support plate 33 and the one surface of the other support plate 33 so as to be fitted into the grooves 33b of these surfaces.

Such a heating device 30 can be easily produced by the same casting method as for the heating devices 10 and 20 of the aforementioned First and Second Embodiments.

The heating device 30 can be applied to the film forming apparatus 100 in the same manner as are the heating devices 10 and 20 of the First and Second Embodiments.

In the First Embodiment, the sheathed heater 12 is vertically sandwiched between the support plates 13. In the Second Embodiment, the sheathed heater 12 is horizontally sandwiched between the support plates 23. In the present embodiment, on the other hand, the sheathed heater 12 is vertically sandwiched between the support plates 33 such that the sheathed heater 12 is fitted into the grooves 33b of the support plates 33, whereby the sheathed heater 12 is surrounded with the support plates 33 from both of the vertical direction and the horizontal direction.

Hence, the following effects can be obtained according to the present embodiment:

(1) Like the heating devices 10 and 20 of the First and Second Embodiments, the heating device 30 comprises the support base 11 of aluminum or an aluminum alloy, and the support plates 33 provided in the support base 11, the support plates 33 (melting point: 1,400° C. or higher) each comprising a material having a melting point of 850° C. or higher. Thus, even when the support base 11 is heated to 400 to 500° C., the support base 11 can be held, without being deformed, by the support plates 33, so that the substrate 108 can be held stably.

(2) Like the heating devices 10 and 20 of the First and Second Embodiments, the heating device 30 is produced by the casting method such that the sheathed heater 12 and the support plates 33 are built into the support base 11. Thus, the heating device 30 can be continuously produced with ease, as compared with the conventional heating device 110 which is produced by cutting the support base 111 to form the groove 111a, laying the sheathed heater 112 in the groove 111a, then fitting the cover 111b onto the groove 111a, and welding the cover 111b. Consequently, the manufacturing cost can be reduced markedly.

(3) In the same manner as in the First and Second Embodiments, the molten metal 5 undergoes cooling and solidification taking place in one direction from the lower side to the upper side (namely, directional solidification). Thus, the molten metal 5 can be solidified without occurrence of defects, such as gas holes and shrinkage cavities.

(4) As in the heating devices 10 and 20 of the First and Second Embodiments, the holes 33a in a honeycomb pattern are formed in the support plates 33 of the heating device 30. Thus, weight reduction can be achieved, with rigidity being retained. Moreover, directional solidification of the molten metal 5 for the production of the heating device 30 by casting can be performed uniformly. Accordingly, the product of a higher quality can be obtained.

(5) The support plates 33 are provided within the support base 11 so as to surround the sheathed heater 12 from both of the vertical direction and the horizontal direction, namely, so as to be symmetric with respect to the sheathed heater 12 in the vertical direction. Thus, as in the heating devices 10 and 20 of the First and Second Embodiments, the speed of heating of the support base 11 by the sheathed heater 12 in the vertical direction is uniformized, and differences in thermal expansion of the support base 11 in the vertical direction can be eliminated. Hence, the warpage of the support base 11 upon heating can be prevented, and the substrate 108 can be stably held more reliably.

(6) Furthermore, the support plates 33 are provided within the support base 11 so as to surround the sheathed heater 12 from both of the vertical direction and the horizontal direction. Thus, rigidity can be further increased as compared with the heating devices 10 and 20 of the First and Second Embodiments, and stable holding of the substrate 108 can be performed more reliably.

The magnitude of rigidity of the support plates 13, 23 and 33 is as follows: support plate 23<support plate 13<support plate 33.

Other Embodiments

In the First, Second and Third Embodiments, the slab-shaped support plates 13, 23, 33 having the holes 13a, 23a, 33a in a honeycomb pattern are used. However, the present invention is not restricted to such support plates 13, 23, 33, but can use support plates having holes, for example, each in a circular shape, each in a triangular shape, or in a lattice pattern. However, it is preferred to use the slab-shaped support plates 13, 23, 33 having the holes 13a, 23a, 33a in a honeycomb pattern as in the First, Second and Third Embodiments, because they can exhibit the greatest force in opposition to stress such as thermal expansion, if any.

In the First, Second and Third Embodiments, the molten metal 5 is naturally cooled via the metal mold 1. However, the metal mold 1 may be cooled with water to cool the molten metal 5 forcibly.

In the First, Second and Third Embodiments, explanations have been offered for the plasma CVD film forming apparatus 100 for producing a semiconductor or a liquid crystal by holding and heating the substrate 108 by use of the heating device 10, 20 or 30, and throwing the plasma 107 of the gas 106 of the material for a film from the plasma generating device 102 onto the substrate 108, thereby forming the film 109 on the substrate 108. However, the present invention is not restricted to this plasma CVD film forming apparatus 100. Any film forming apparatus, which comprises a heating device for holding and heating an article to be heated, and film material throwing means for throwing a material for a film onto the article to be heated, can be applied to the present invention in the same manner as in the First, Second and Third Embodiments.

The present invention, having the above-described features, produces the following effects:

The heating device according to the present invention comprises a support base adapted to support an article to be heated and comprising aluminum or an aluminum alloy, heating means provided within the support base, and a skeletal member provided within the support base and comprising a metallic material having a melting point of 850° C. or higher. Thus, even when the support base is heated to 400 to 500° C. by the heating means, the support base can be held, without being deformed, by the skeletal member. Moreover, the article to be heated, which has been placed on the support base, can be held stably.

The skeletal members are disposed so as to be vertically symmetrical with respect to the heating means. Thus, the speed of heating of the support base by the heating means in the vertical direction is uniformized, and differences in thermal expansion of the support base in the vertical direction can be eliminated. Hence, the warpage of the support base upon heating can be prevented, and the article to be heated, which has been placed on the support base, can be stably held more reliably.

Also, the skeletal member is slab-shaped, and thus can hold the support base reliably.

Also, a plurality of holes are formed in the skeletal member. Thus, weight reduction can be achieved.

The holes are in a honeycomb pattern. Thus, weight reduction can be achieved, with rigidity being retained most efficiently.

Also, the aluminum alloy has low contents of magnesium and copper. Thus, a semiconductor or a liquid crystal can be produced, without adverse influence.

Also, the skeletal member comprises one of iron, steel, nickel, a nickel alloy, titanium, a titanium alloy, copper, and a copper alloy. Thus, the skeletal member can be produced at a low cost if it comprises iron or steel; the heat resistance of the skeletal member can be increased if it comprises nickel or nickel alloy; the thermal conductivity of the skeletal member can be increased if it comprises copper or copper alloy; and the weight of the skeletal member can be decreased if it comprises titanium or titanium alloy.

The method for producing a heating device, according to the present invention, comprises disposing heating means within a mold having a lower portion comprising a metal mold and a side portion comprising a sand mold; pouring a melt of aluminum or an aluminum alloy into the mold; and covering a surface of the melt with an exothermic heat insulating material, whereby directional solidification of the melt takes place from a lower side toward an upper side to cast the melt. This method gives the following advantages over the conventional method, which comprises cutting a support base to form a groove, laying heating means in the groove, then fitting a cover onto the groove, and welding the cover: Continuous production can be facilitated, and the manufacturing cost can be reduced markedly. Furthermore, the melt can be solidified without occurrence of defects, such as gas holes and shrinkage cavities. Consequently, the heating device of satisfactory quality can be produced.

An alternative method for producing a heating device, according to the present invention, is a method for producing the above-mentioned heating device, comprising disposing the heating means and the skeletal member within a mold having a lower portion comprising a metal mold and a side portion comprising a sand mold; pouring a melt of aluminum or an aluminum alloy into the mold; and covering a surface of the melt with an exothermic heat insulating material, whereby directional solidification of the melt takes place from a lower side toward an upper side to cast the melt. This method gives the following advantages over the conventional method, which comprises cutting a support base to form a groove, laying heating means in the groove, then fitting a cover onto the groove, and welding the cover: Continuous production can be facilitated, and the manufacturing cost can be reduced markedly.

The film forming apparatus, according to the present invention, comprises the above-mentioned heating device for holding and heating an article to be heated; and film material throwing means for throwing a material for a film onto the article to be heated. This film forming apparatus makes it possible, without problems, to form a film on the article to be heated, while heating this article to a temperature of 400 to 500° C. Hence, the film forming apparatus, if applied, for example, to the production of a semiconductor or a liquid crystal, can produce a high performance semiconductor or liquid crystal with high efficiency.

While the present invention has been described in the foregoing fashion, it is to be understood that the invention is not limited thereby, but may be varied in many other ways. Such variations are not to be regarded as a departure from the spirit and scope of the invention, and all such modifications as would be obvious to one skilled in the art are intended to be included within the scope of the appended claims.

What is claimed is:

1. A heating device comprising:
a support base adapted to support an article to be heated and comprising aluminum or an aluminum alloy;
heating means provided within the support base; and
a skeletal member provided within the support base and comprising a metallic material having a melting point of 850° C. or higher.

2. The heating device of claim 1, wherein
the skeletal members are disposed so as to be vertically symmetrical with respect to the heating means.

3. The heating device of claim 1, wherein
the skeletal member is slab-shaped.

4. The heating device of claim 3, wherein
a plurality of holes are formed in the skeletal member.

5. The heating device of claim 4, wherein
the holes are in a honeycomb pattern.

6. The heating device of claim 1, wherein
the aluminum alloy has low contents of magnesium and copper.

7. The heating device of claim 1, wherein
the skeletal member comprises one of iron, steel, nickel, a nickel alloy, titanium, a titanium alloy, copper, and a copper alloy.

8. A method for producing a heating device, comprising:
disposing heating means within a mold having a lower portion comprising a metal mold and a side portion comprising a sand mold;
pouring a melt of aluminum or an aluminum alloy into the mold; and
covering a surface of the melt with an exothermic heat insulating material,
whereby directional solidification of the melt takes place from a lower side toward an upper side to cast the melt.

9. A method for producing the heating device of claim 1, comprising:
disposing the heating means and the skeletal member within a mold having a lower portion comprising a metal mold and a side portion comprising a sand mold;
pouring a melt of aluminum or an aluminum alloy into the mold; and
covering a surface of the melt with an exothermic heat insulating material,
whereby directional solidification of the melt takes place from a lower side toward an upper side to cast the melt.

10. A film forming apparatus comprising:
the heating device of claim 1 for holding and heating an article to be heated; and
film material throwing means for throwing a material for a film onto the article to be heated.
